(19) United States
(12) Patent Application Publication
(10) Pub. No.: US 2025/0238840 A1
(43) Pub. Date: Jul. 24, 2025

(54) SYSTEM FOR DELIVERING ADVERTISEMENT CONTENT

(71) Applicant: Rashrash FARES, AKKO (IL)

(72) Inventor: Rashrash FARES, AKKO (IL)

(21) Appl. No.: 19/032,735

(22) Filed: Jan. 21, 2025

(30) Foreign Application Priority Data
Jan. 23, 2024 (IL) 310350

(51) Int. Cl. G06Q 30/0251; G06Q 30/0207; G06Q 30/0242; G06T 7/20; G06V 40/20

(52) U.S. Cl. CPC G06Q 30/0252; G06Q 30/0207; G06Q 30/0242; G06T 7/20; G06V 40/23; G06V 40/28

(57) ABSTRACT

A system for delivering advertisement content includes an advertising apparatus having an advertisement screen display for displaying advertisements content, at least one advertisement server, said server having advertisement content, and data analysis of the users' gestures by said advertisement server. At least one user interacts with said displaying advertisements content that displayed on said screen display through a predetermined at least one gesture, thereby these interactions transform passive advertising viewing into an immersive and participatory experience.

### RELATED APPLICATION

This application claims priority to Isreal Patent Application No. 310350, filed Jan. 23, 2024, entitled SYSTEM FOR DELIVERING ADVERTISEMENT CONTENT, by Rashrash Fares, the contents of which are incorporated herein by reference.

### TECHNICAL FIELD

The present invention relates to advertisement, in particular to a system for delivering advertisement content.

### BACKGROUND OF THE INVENTION

A system for delivering advertisement content typically involves a set of technologies and strategies for distributing advertising messages to targeted audiences. This system can be quite complex, incorporating various components and methodologies. Below some key aspects of such systems, Ad Server and Delivery Mechanisms: A core component is an ad server, which stores the advertisement content and serves it to viewers. The ad server is responsible for the decision-making process about which ads to show based on the targeting criteria. It also tracks the performance of the ads (e.g., number of views, engagement actions, clicks). Another aspect is targeting and personalization. Modern ad delivery systems use sophisticated algorithms to target ads to specific user segments. This can be based on demographics, user behavior, interests, location, and other factors. Personalization ensures that the ads are relevant to the viewers, increasing the likelihood of engagement. Another aspect is asynchronous Ad Delivery. This method involves delivering ads in a way that does not interfere with the user's experience. For example, ads can be pre-loaded or delivered at times when they are less intrusive. Another aspect is multi-platform capability. Effective ad delivery systems are capable of serving ads across different platforms and devices, such as desktops, mobile phones, tablets, and connected TVs. This cross-platform capability ensures a wider reach. Another aspect is efficient bandwidth usage. In video advertising, especially, efficient use of bandwidth is crucial. This involves optimizing the ad content for different connection speeds and device capabilities to ensure smooth delivery without buffering. Another aspect is performance tracking and analytics. These systems often include robust analytics to track the performance of ads. This data is used to measure the effectiveness of ad campaigns and to optimize future advertising efforts. Yet another aspect is QR code integration. Some systems might incorporate QR codes to engage users further. When a viewer scans the QR code, they can be directed to additional content, offers, or interactive experiences. Yet another aspect is interactive elements. Advanced systems may allow interactions with the ad, such as clicking to get more information, filling out a form, or making a purchase directly from the ad. Yet another aspect is geographical and contextual Relevance. Ads can be targeted based on the geographical location of the viewer and the context in which they are viewing the ad. For example, an ad for a local service will be more relevant to someone in the service's geographical area. Another aspect is Content Delivery Networks (CDNs). CDNs are often used to deliver ads quickly and reliably. They store copies of ads in multiple locations geographically closer to the user, reducing latency. Yet another aspect is programmatic advertising. Many modern ad systems use programmatic advertising, where ads are automatically bought and sold using algorithms, allowing for real-time bidding and placement. This makes ad buying more efficient and can lead to better targeting. Each of these of these aspects have a role in ensuring that advertisement content is delivered effectively to the intended audience, with the ultimate goal of driving engagement and achieving the advertisers' objectives.

US20160042401 discloses targeted advertisements to a charging station for electric vehicles. A data collector records data associated with individuals near a charging station. A meter determines whether the charging station is being used to charge an electric vehicle. When the charging station is being used, a display displays advertisements targeted to the individuals. The targeted advertisements are selected from a database according to the data recorded by the data collector, and the database stores advertising content with discrete advertising segments that are electronically accessible. A processor is coupled to the data collector, the meter, and the display. The processor transmits the data recorded by the data collector, and receives the targeted advertisements.

US20120158502 discloses an advertisement engine, a computer-implemented method, and computer-readable media to select advertisements. The advertisement engine is connected to an advertisement database and user database. The advertisement engine selects advertisements from the advertisement database based on user engagement data associated with a user. The user engagement data is stored in the user database. The user engagement data includes the length of time a user focused on content displayed by a client device.

US20160292713 discloses methods and apparatus by which advertising channels in public spaces are configured to deliver adaptive and targeted advertising in real time. Real-time, contextual information is used to make determinations about the likely audience currently in position to view an advertising channel (e.g., a digital billboard). Appropriate advertisements are then selected based on those determinations. Techniques for measuring user engagement with advertising content are also described.

U.S. Pat. No. 11,037,193B1 discloses a computer-implemented method for presenting content based on information detected in real time includes: receiving first information corresponding to detection of at least attendance at a physical location; selecting, in real time with the detection, at least one winning bid based on the first information, the at least one winning bid conditioned on the first information meeting an attendance criterion; and providing at least one winning content item associated with the selected winning bid to a content presentation device at the physical location.

### SUMMARY OF THE INVENTION

The present invention relates to advertisement, in particular to a system and for delivering advertisement content.

In accordance with one aspect of the present invention there is provided a system for delivering advertisement content. The system includes an advertising apparatus having an advertisement screen display for displaying advertisements content, motion and gestures sensors to interact with advertisements content displayed on said screen display, a controller and a wireless communication module. The advertising apparatus further includes one or more cameras where the system uses the camera capture for image processing algorithms to interpret specific hand or body gestures for operating one or more features of the system. The system of the invention further includes one or more advertisement servers, the server(s) having advertisement content; and data analysis of the users' gestures by the advertisement server. One or more users interacts with the displaying advertisements content that displayed on the screen display through a predetermined at least one gesture. These interactions transform passive advertising viewing into an immersive and participatory experience.

### BRIEF DESCRIPTION OF THE DRAWINGS

The invention may be understood upon reading of the following detailed description of non-limiting exemplary embodiments thereof, with reference to the following drawings, in which:

FIG. 1 is a schematic block diagram of the system in accordance with some embodiments of the present invention.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

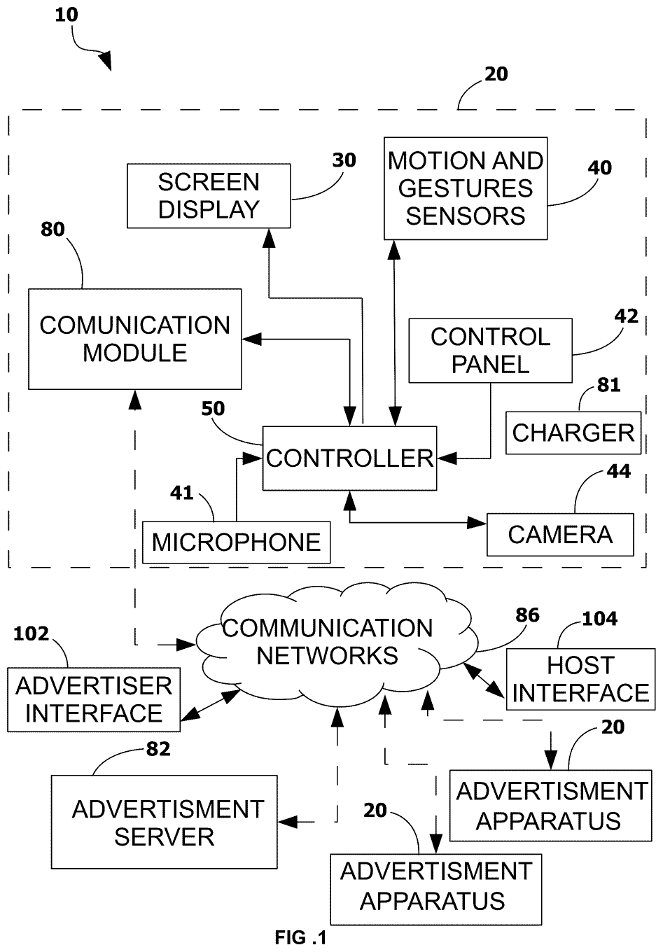

Advertisement delivery system of the present invention involves advertising that combines advanced technology, user interaction, and data-driven decision-making. Referring to FIG. 1, the primary components of system 10 include an advertisement apparatus 20 having a screen display 30, motion and gestures sensors 40, a microphone 41, a control panel 42 to control the advertisement apparatus, a controller 50 or external remote-control device, camera 44 and a wireless communication module 52.

Motion and gestures sensors 40 referred to devices that detect and interpret human gestures as inputs, enabling a more intuitive and interactive way of controlling the system 10. One example of such sensors 40 is 3D Gesture sensors that can detect and interpret three-dimensional hand movements which can be used in interactive screen display(s) 30 and to control one or more of the features of the present invention that will describe later in more detail. Another example of such sensors 40 is ultrasonic gesture sensors these sensors use ultrasonic waves to detect hand movements. They can be used for touchless control of the system 10, like pausing or playing an advertising movie displayed on the screen display 30. Yet another example is infrared (IR) gesture sensors, these sensors use IR light to detect hand motions close to the device, such as swiping or tapping in the air for activating one or more features of the present invention. Another example of such sensors 40 is camera-based gesture Recognition, utilizing standard or depth-sensing camera(s) 44, and uses image processing algorithms to interpret specific hand or body gestures for operating one or more features of the system 10.

In accordance with the present invention the system 10 provides user engagement strategies and data utilization capabilities. One or more users can interact with the displayed content that displayed on screen display 30 through a range of gestures, including hand and finger movements, head tilts or turns, mimics such as but not limited to smiles, and even jumping. This interactive approach transforms passive advertising viewing into an immersive and participatory experience. Moreover, the system 10 offers incentives by awarding viewers with discounts for specific body movements, fostering increased engagement and leaving a lasting impression on the audience. Data analysis of the users' gestures can be analyzed for example by utilizing controller 50 or advertisement server 70 is a central pillar of this system's functionality. The advertisement server 70 may include data analysis that can be harnesses both image analysis and artificial intelligence to gain deep insights into user behaviour and preferences. By tracking user actions and gestures sensor data, the data analysis actively learns about the audience, including their habits, preferences, and engagement patterns. This learning for example extends to determining the most efficient hours or times of the day for advertising and identifying the types of content that resonate most with the viewers. Additionally, it uses circumstantial data, such as environmental conditions or user demographics, to refine content delivery and tailor advertisements to individual viewers. In addition, the system 10 of the present invention can use artificial intelligence algorithms to analyze and predict the success rate of a certain advertisement in a certain geographic region such as but not limited to a city or a neighborhood by analyzing the collected data from motion and gestures sensors 40 and camera 44.

Advertisers that use the system 10 benefit from a flexible and performance-based pricing model. The system 10 can also calculates fees for advertisement content based on a variety of factors, including the number and type of user interactions, location data, and motion sensor data. This dynamic approach ensures that advertisers receive value proportional to the impact their content generates, making advertising expenditures more efficient and measurable.

Practical features further enhance the system's utility. Advertisers can upload and approve content before it is broadcast, ensuring quality control and brand consistency. Furthermore, the system can simultaneously air content across multiple locations, a feature that maximizes reach and effectiveness. This adaptability makes it suitable for diverse deployment scenarios, ranging from businesses and commercial areas to hotel lobbies, storefronts, malls, and even hotel rooms.

The current invention relates to a device and system 10 that can be placed in prominent locations such as but not limited to display areas/showcases of businesses, commercial areas, hotel lobbies, storefronts, malls, and even hotel rooms. The system of the present invention includes screen display 30 having a Screen (TV/other screen). In the screen display 30 there will be a screen and the screen will present commercial content to people who walk in relatively proximity. In accordance with the present invention the motion and gestures sensor(s) 40 will detect the people walking by the screen 30, stopping, performing hand gestures, head movement, a smile, etc. The system 10 may further includes a physical and/or virtual sign indicating the variety of acceptable/understandable gestures to be used to interact with the system 10. Each person passing by the screen can stop to interact with the screen 30 and the displayed content using hand gestures or other predetermined bodily movements such as but not limited to, hand gestures, finger gestures, head movements (turning/leaning), smiles, facial expressions, sounds, vocal expressions, jumping or any combination thereof. Any other type of body movement that is predetermined as a motion that indicates a specific action for the system. For example, a hand wave to the right side indicates to the system to rewind or play the previous advertisement. In another example, a finger pointing upwards can indicate to the system 10 to pause the video being shown. These gestures can do the following actions: Play, Forward, Rewind, get or claim a discount, Pause, show a barcode/an element to be scanned by the viewer's mobile phone, send information to the viewer's phone (using Bluetooth), send information to the viewer's email, Buy now, show route of how to get from the current physical location of screen 30 directly to a location advertised in the advertised content or a product or service sold or provided in said location etc. These actions and movements can also be combined with vocal expressions, e.g. a smile or a hand wave combined with saying a brand, possibly at least a predefined volume to achieve further interest by other people who are close by. Certain predetermined body movements can award the viewer with a discount on the price of the advertised content/a prize/gift/coupon. The system 10 can use the gesture sensors 40 to count the number of people that pass by the screen in each predefined time frame, e.g. a day, an hour, in a predefined distance from the screen, e.g. 2-5 meters away. The system 10 may also perform additional data analysis based on the behavior of each viewer and the accumulated data thereof.

In accordance with some embodiments of the present invention the data from the sensors 40 and camera(s) 44 can be sent to an advertisement server 82 through communication module 80 and communication network(s) 86 that can analyze the data and learn for example to indicate which hour or time throughout the day is the most efficient by counting the relative amount of people that stop and interact with the screen from the total number of people that pass by the screen 30 and the number thereof. Said indications (possible conclusions) from said data analysis can also be referenced to a specific content, a specific location or geographical zone, certain types of people that are more prone to engage with a specific content or type thereof, or certain body movements and gestures that are more successful in that aspect of generation a higher rate of viewer participation.

The data from the sensors 40, camera(s) 44 or microphone 41 can be sent to the advertisement server 40 to analyze which hour or time throughout the day is the most efficient time by counting the relative amount of people that complete a purchase of a service or product inferred from the advertisement that was displayed on screen 30. The advertisement server 40 may also analyze the data to indicate which hour or time throughout the day is the most efficient by counting the relative amount of people that stop to look at the screen for at least a predetermined amount of time.

The data from the sensors 40, camera(s) 44 or microphone 41 can be sent to the advertisement server 40 to analyze which advertisement add location is the most efficient time by counting the relative amount of people that complete a purchase of a service or product inferred from the advertisement that was displayed on screen 30.

The advertisement server 40 may also analyze the data to indicate which type of advertisement content is more effective for which type of crowd based on available data and location (children-oriented content that is placed near a kinder garden/school. Women-oriented content is more effective near successful women's clothing stores etc). The system 10 may also use circumstantial data as an indicator to better determine the type of individual standing before it, e.g. to assume a likelihood it's a child based on height, gender-based on walking patterns like walking on heels, or a man based on walking patterns, posture, and size. By knowing the current type of individual that stands before the screen 30 the system may stream a relevant advertisement data on the screen 30. In some embodiments of the present invention the system 10 may also identify when a person is facing the screen, its relative distance, and the direction of its head in relation to the screen.

In accordance with the present invention the controller (having a memory for storing instruction sets) 50 or advertisement server 82 may include the following computer instructions sets of software that includes the following features. The system's software will include the feature of information pertaining the detection of people, detection of body parts, the detection of the Gestures as explained above. Information pertaining the connection of Gestures to Digital Actions. Another software feature is continuous sensors data analysis. In some embodiments of the present invention one or more modules of the features software can be stored on a cloud. One or more features of the system's software may include artificial Intelligence and image recognition technology for example to learn the behavior of client and potential clients to purchase goods and services. Another feature of the system's software may include controlling the screen action and determine which content will be shown on each screen for example the advertiser can provide advertisement content to the advertisement server 82 publish the advertising material. In some embodiments of the present invention advertisement apparatus 20 receives content that advertiser provide in the advertisement server. In other embodiments of the present invention the business where the advertisement apparatus 20 is positioned may ha control on the content that will be displayed on display 30 and when a certain advertisement is displayed. For example, if advertisement apparatus 20 includes adult advertisement content that fits for viewers above 18 years old then the business that uses the advertisement apparatus or host (the person who owns the real estate where the advertisement apparatus 20 is placed) have the option to decide whether an adult content will display on display 30.

Another feature may include to generate/calculate a fee to be paid to the host (the person who owns the real estate where the system 10 is placed) based on the number and type of digital actions taken, or other criteria such as but not limited to the number of people that stop to interact with the system 10, pass by the system 10, scan barcodes presented by the system, or any other action that is suggested by the system 10. Same data can also be used to determine the optimal cost to charge the Client (the person who pays to present the advertised content).

In accordance with the present invention advertisement client advertisers that wants to use the system of the present invention can communicate with the software in such way that each client will be able to upload his content advertisement server 82 for clearance and verification before the advertisement content is aired on screens 30, contingent upon payment and also after the requested parameters have been chosen by the advertisement clients which could for example the type of crowd that the advertisement content is aimed for, what age, which desired location, how long, how many times the advertisement is to be shown each day etc. Advertisement clients can pay for their respective content to be displayed in various locations throughout the world, wherever the apparatus 20 of system 10 is installed.

In accordance with other embodiments of the present invention the system 10 can play and display on screen 30 the customer's content simultaneously in multiple locations using multiple advertisement apparatuses 20 of system 10, based on the potential effectiveness of the advertisement and the willingness to pay for such an advertisement.

In accordance with other embodiments of the present invention the screen 30 can be a T.V screen, projector, Hologram projector, and any known device that can project visual content.

In accordance with other embodiments of the present invention the system 10 can play and display on screen 30 the customer's content simultaneously in multiple locations using multiple apparatuses 20 of system 10, based on the relevancy of the product/service to each location and the type of crowd passing by each apparatus 20 of system 10 in each specific location as can be learned by the system after analysis of information from the sensors and potential clients engagements and user interactions.

In accordance with other embodiments of the present invention the system 10 can also play and display on screen 30 the customer's content at a predefined time in various locations worldwide in multiple locations, based on the various time zones and locations using multiple apparatuses 20 of system 10. The cost of each advertisement can be determined by its location (which country, local buying power) and by the number of individuals passing by the screen in each predefined time frame, e.g. a day, in a predefined distance from the screen, e.g. 2-5 meters away. (i.e. the demand/cost of each screen is determined by the financial potential resulting from showing a certain commercial content in a certain location, time and size of potential spectators.

The assessment of the attractiveness level of the advertisement on screens 30 can be assessed for example by the number of people that interacts with apparatus 20, how many people stop in front of the screen 30, how long people stayed in front of the screen (for example at least 5 seconds). The assessment of the attractiveness level of the advertisement on screens 30 can be further assessed for example by how many QR code scans were made, meaning that the advertisement that is displayed on screen 30 may include a QR code that connects the user to the advertiser web page to purchase product and/or services. When a viewer scans the QR code, they can be directed to additional content, offers, or interactive experiences.

The assessment of the attractiveness level of the advertisement on screens 30 can be further assessed for example by the percentage of scans relative to the people who stopped. Also, Number of interactions with the screen, Geographical location (country) according to purchasing power. Relevance index according to city and location within the city (positive or negative scoring if the advertisement is not suitable for the type of product, or if the location is exactly next to a specific market segment such as a nursing home or university or a tourist area that indicates a large number of people on vacation). Lastly, the advertisement relevance based on information previously collected about the operation of the screen in the specific location in the past.

Calculation of advertising time attractiveness for each screen 30 can be assessed according to advertisement demand times, past performance on the same screen, and advertisement displayed at night day or both.

The assessment of the attractiveness level of the advertisement on screens 30 can be further assessed similarly to programmatic advertising, also considering supply and demand in real-time, where ads are automatically bought and sold using algorithms, allowing for real-time bidding and placement thereby allowing Brick and Mortar business owners to also benefit from their real estate in a way of programmatic advertising. In accordance with one embodiment of the invention, there is an additional suitable interface for costumers to allow the transactions of advertisement purchases by time and location.

The assessment of the attractiveness level of the advertisement can also be based on a calculation of all or any combination of the factors that were explained above in detail.

In accordance with the present invention the following entities, the business that uses the advertisement apparatus, host (the person who owns the real estate where the advertisement apparatus 20 is placed) and the business advertisers that provide the content to the advertisement apparatus 20 each have an interface 102 and 104 to control and mange the content that viewers will see on the screen display. These entities may also have different permission to control and manage system 10.

In accordance with another embodiment of the present invention the system 10 can also include a wireless charging spot or location 81 and use the wireless charging spot to inform potential users passing by the system 10 (using the microphone 41) about the possibility of charging their phones or electrical devices for free while being in a close proximity to system 10, thus attracting potential users.

In accordance with another embodiment of the present invention the system 10 can also include a Wi-Fi hot spot and use the Wi-Fi hot spot to inform potential users passing by the system 10 (using the microphone 41) about the possibility of using the Wi-Fi connectivity while being in a close proximity to system 10, thus attracting potential users.

The management interface for advertisers 102 allows them to upload content, define who the desired audience is, in which places or countries they want to advertise, budget, movements they would like customers to make to receive benefits, location of the business, etc. and to purchase the right to advertise and choose where the advertisements will be displayed.

The host interface 104, of the owner of the place where the physical screen is located, allows limiting the type of content and monitoring the performance of the system and the revenue it generates for him.

One of the benefits of the present invention is that this invention can be a tool for business and store owners to generate income from marketing in an innovative way.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A system for delivering advertisement content comprising:
an advertising apparatus having an advertisement screen display for displaying advertisements content;
the advertising apparatus further having motion and gestures sensors to interact with advertisements content displayed on said screen display;
the advertising apparatus further having a controller and a wireless communication module;
the advertising apparatus further having at least one camera where said system uses said camera capture for image processing algorithms to interpret specific hand or body gestures for operating one or more features of said system;
at least one advertisement server, said server having advertisement content; and data analysis of the users' gestures by said advertisement server;
wherein at least one user interacts with said displaying advertisements content that displayed on said screen display through a predetermined at least one gesture,
thereby these interactions transform passive advertising viewing into an immersive and participatory experience.

2. A system for delivering advertisement content according to claim 1, wherein said advertisement server having data analysis that can harness both image analysis and artificial intelligence to gain deep insights into user behavior and preferences by tracking user actions and gestures sensor data, the data analysis actively learns about the audience, including their habits, preferences, and engagement patterns; this learning extends to determining the most efficient hours or times of the day for advertising and identifying the types of content that resonate most with the viewers; additionally, said server uses circumstantial data, of environmental conditions or user demographics, to refine content delivery and tailor advertisements to viewers of said screen display.

3. A system for delivering advertisement content according to claim 1 wherein said system further comprising a control panel to control said advertisement apparatus.

4. A system for delivering advertisement content according to claim 1 wherein, the interaction with said screen display is done by at least one of hand gestures, finger gestures, head movements, mimics, jumping and voice.

5. A system and for delivering advertisement content according to claim 1 wherein, awarding viewers with a discount for certain predetermined viewers' gestures.

6. A system for delivering advertisement content according to claim 1 wherein, said system further learn to indicate which hour or time throughout the day an advertisement is the most efficient based on data received from said motion and gestures sensors.

7. A system and for delivering advertisement content according to claim 1 wherein, said system further learn to indicate which type of advertisement content is more effective based on data analysis of data collected from said motion and gestures sensors.

8. A system for delivering advertisement content according to claim 1 wherein, said system further comprising data analysis of said gesture sensors data and camera date using image analysis algorithms and artificial intelligence algorithms.

9. A system for delivering advertisement content according to claim 1 wherein, said system further calculate a fee to be paid for the advertisement content based on the number/type of Digital Actions taken/location/motion sensor data; calculate a fee to be paid for the advertisement content based on the advertisement location.

10. A system for delivering advertisement content according to claim 1 wherein, said system further comprising advertiser interface and host interface for controlling, managing advertisement content.

11. A system for delivering advertisement content according to claim 10 wherein, said host interface comprising permission option for permitting or not permitting a certain advertisement content to be displayed on said display.
